(19) United States
(12) Patent Application Publication
(10) Pub. No.: US 2012/0228309 A1
(43) Pub. Date: Sep. 13, 2012

(54) METAL COMPOSITE PRESSURE CYLINDER

(76) Inventors: Sergeri Vladimirovich Lukyanets, Khotkova (RU); Nikolai Grigorievich Moroz, Khotkova (RU)

(21) Appl. No.: 13/508,857

(22) PCT Filed: Nov. 13, 2009
(86) PCT No.: PCT/RU2009/000622

§ 371 Date: May 31, 2012

(51) Int. Cl. F17C 1/02

(52) U.S. Cl. 220/592

(57) ABSTRACT

The technical result of the proposed invention is the absorption of the impact energy. The technical result is achieved by using metal composite pressure cylinder that contains a closed thin metal sealing liner, a pressure overwrap made of composite material formed by a combination of groups of layers of reinforcing material made of high-modulus filaments orientated in spiral and circumferential directions, and a protective overwrap fabricated from a composite material made of a group of layers of reinforcing material made of low-modulus filaments. Herewith, an energy damping shock absorber is installed on the part of the surface of at least one of the bottoms, between the group of high-modulus reinforcing material of pressure overwrap and a group of the layers of low-modulus reinforcing material of protective overwrap; the above shock absorber comprises a rigid profiled frame on the side of protective overwrap and a damping device on the side of the pressure overwrap which are interconnected.

### TECHNICAL FIELD

The invention refers to a field of gas fittings, namely, metal composite pressure cylinders used in particular for portable oxygen breathing apparatus for climbers, rescue workers, in portable devices of cryogenic and fire-fighting equipment, gas supply systems, automotive and other industries.

### PREVIOUS TECHNICAL LEVEL

Currently available metal composite high pressure cylinders contain internal thin metal sealed overwrap, a liner, and an outer pressure overwrap made of composite material formed by winding on the surface of the liner of high modulus fibre cords (e.g. carbon fibre) impregnated with a binder.

Among the requirements for high pressure gas cylinders, the following are of top-priority: decrease of specific consumption of materials, determined by a ratio of a cylinder weight to its volume, and provision of a long lifetime determined as a number of load cycles within safe operation of the cylinder.

According to current regulatory documents, apart from the above requirements, there are additional requirements such as the cylinder survival and reliable work after the filled cylinder falls from a specified height or after it is exposed to a local shock with a specified impact energy.

There are numerous examples of pressure cylinders with metal liners made of various alloys (see, e.g., U.S. Pat. No. 5,494,188, U.S. Pat. No. 5,538,680, U.S. Pat. No. 5,653,358, U.S. Pat. No. 5,862,938, U.S. Pat. No. 5,938,209, U.S. Pat. No. 5,979,692, U.S. Pat. No. 6,190,598, U.S. Pat. No. 6,202,674, U.S. Pat. No. 6,202,674, U.S. Pat. No. 6,230,922, US 2003111473, U.S. Pat. No. 6,810,567).

However, these constructions cannot completely provide a solution of the problem of the reliability of a construction exposed to local mechanical stress.

There are examples of pressure composite cylinders with use of special layers made of different materials (see, e.g., patents, EP1156266, WO2006076029, WO2004020544, WO1982001580, U.S. Pat. No. 6,230,922, U.S. Pat. No. 5,004,120, U.S. Pat. No. 5,476,189), which allow to partially solve the problem of the cylinder stability to local stress.

The prototype model of the proposed construction of the cylinder is the construction described in U.S. Pat. No. 5,476,189, Mar. 12, 1993. In this construction, additional elastic layers made of viscoelastic material such as rubber, are used as a structural element to absorb a shock.

The cylinder is a construction containing internal thin metal liner and outer overwrap made of high modulus high-tenacity composite material, on the surface of which another overwrap is wound around made of low-modulus composite material. For the redistribution of the impact force (increase of contact area) between the composite overwraps or at the outer surface, a layer of elastic material such as rubber is provided.

The drawback of this solution is the following: when the cylinder overwrap is stroked there is no impact absorption with regard to the decrease of local force affecting on the cylinder pressure overwrap, and only local contact area is rearranged which allows to solve the set target only partially.

### DISCLOSURE OF INVENTION

The purpose of the present invention is to create a high-pressure metal-plastic cylinder, the structure of which can ensure its survival in the specified conditions of local dynamic force resulting from the cylinder fall from a specified height or a stroke with an object of a specific impact energy, and thereby increase the cylinder lifetime.

The technical result of the proposed invention is the absorption of the impact energy due to rigid profiled frame and absorption of a part of impact energy due to damping device, which redistributes the area of contact with the pressure overwrap.

The technical result is achieved because the metal composite pressure cylinder contains a closed thin metal sealing liner, a pressure overwrap made of composite material formed by a combination of groups of layers of reinforcing material made of high-modulus filaments orientated in spiral and circumferential directions, and a protective overwrap made of composite material fabricated of a group of layers of reinforcing material made of low-modulus filaments. Herewith, an energy damping shock absorber is installed on a part of the surface of at least one of the bottoms, between the group of high-modulus reinforcing material of pressure overwrap and a group of the layers of low-modulus reinforcing material of protective overwrap; the above shock absorber comprises a rigid profiled frame on the side of protective overwrap and a damping device on the side of the pressure overwrap which are interconnected.

The profiled frame of the shock absorber may be fabricated as a overwrap in the shape of a part of ellipsoid of revolution with a curvature that is greater than the curvature of the pressure overwrap surface.

The profiled frame of the shock absorber may be made in the form of the system of intersecting overwraps, arranged in rows with formation of cavities in the place of their connection.

The profiled frame of the shock absorber may be fabricated as a profiled ribbed elastic overwrap.

The profiled frame of the shock absorber on the places of contact with the pressure overwrap may be designed in the form of a crown, on the petals of which of a damping device is fixed.

The damping device of the shock absorber can be made as an damping assembly, comprising of braced layers of ballistic soft tissue substrate made of dry high-tenacity (e.g., glass or aramid) fibres covered with release hydro-oleophobic coating, layers of low density viscoelastic material (e.g. polyurethane foam or rubber), and the covering layer of elastic moisture-proof material on the side of the pressure overwrap.

The layers of ballistic soft substrate of damping device may be fabricated from a set of braced damping filaments made of high-tenacity material, which are mounted and fixed in the section chord of elliptical overwrap of the frame, forming a star-shape configuration, or layers of soft tissue substrate made of dry high-tenacity (aramid) fibres may be fixed on the crown petals with use of cross-cut slits in the tissue forming layers.

### SUMMARY OF THE INVENTION DRAWINGS

FIG. 1 shows the cylinder general view.

FIG. 2 shows general view of the part of the cylinder bottom with a shock absorber.

FIG. 3 shows space diagram of a shock absorber.

FIGS. 4-6 show design shapes of the shock absorber frame versions.

FIGS. 7-8 show connection pattern of the shock absorber with the damping device made of dry reinforced fibres and fixed with a cover layer on the frame.

FIG. 9 shows a diagram of damping device version made of dry high-tenacity fibres.

FIG. 10 shows a shock absorber diagram with the device made of viscoelastic material.

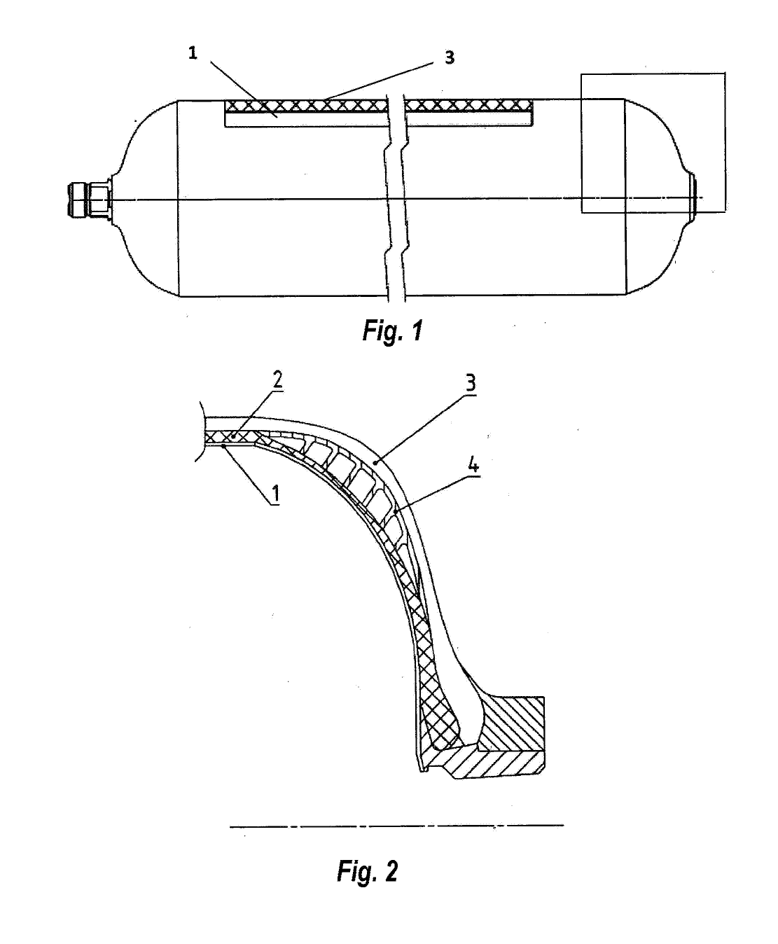

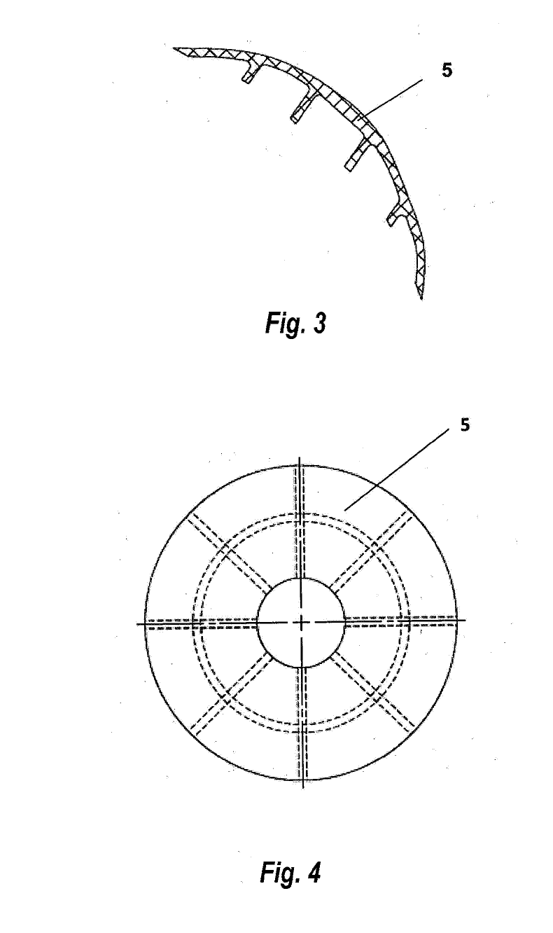

### EMBODIMENTS OF THE INVENTION

A metal composite pressure cylinder contains closed thin metal sealing liner 1, pressure overwrap 2 made of composite material formed by the combination of groups of layers of reinforcing material made of high-modulus filaments orientated in spiral and circumferential directions, and protective overwrap 3 made of composite material made of a group of layers of reinforcing material made of low-modulus filaments, and protective overwrap made of composite material formed by a group of layers of low-modulus filaments fabricated from reinforcing material.

As a rule, when the cylinder is shocked or falls down, the most dangerous zones are the zones of the bottoms where the overwraps are thin and their curvatures are doubled, therefore they are structurally rigid to an impact. One of the curvatures of the cylindrical part of the cylinder is a zero curvature, which allows it to deform locally without significant stress in the material of the pressure overwrap. Therefore in falling or local shock, it is feasible to protect only the bottoms of the cylinder pressure overwrap.

For this purpose between overwraps 2 and 3, energy damping shock absorber 4 is installed consisting of rigid profiled frame 5 and damping device 6 with internal covering layer 7 of material. Damping device 6 is made as a damping assembly consisting of separate layers 9 of elastic material (e.g. rubber) and braced layers 10 of ballistic soft tissue substrate made of dry high-tenacity fibres. At that, the damping device consists of cover layer 7 made of elastic material mounted on the side of pressure overwrap 2 and rigidly fastened to frame 5 of shock absorber 4. The layers 10 of soft ballistic tissue substrate made of dry high-tenacity fibres are also rigidly fastened to frame 5 of shock absorber 4. Cover layer 7 also performs its technological function to protect against the penetration of liquid resin in the group of layers of the damping device of shock absorber, during the fabrication of the cylinder. This layer should be made of a flexible moisture-proof material.

The principal difference of this construction compared to the prototype is that the shock absorber is energy absorbing.

The construction functions as follows: at the moment when an impactor contacts with the cylinder (or falling cylinder contacts with a contact surface), the contact force causes the deflection of low-modulus layers of overwrap 3 and 5 frame of shock absorber 4. Due to the rigidity of the construction consisting of low-modulus layers of overwrap 3 and frame 5 of shock absorber 4, as well as double curvature of their surface, a part of the impact energy is absorbed in the form of the potential energy of deformation of the layered structure. The magnitude of the energy absorbed depends on the magnitude of the construction deflection in a contact zone. Simultaneously with this construction deflection, layers 9, 10 of the materials of damping device 6 are compressed, and a part of the load pressure is transferred to overwrap 2 and cylinder liner 1. Herewith, because of compressive stiffness in layers 10 of damping device 6 of shock absorber 4, a part of impact energy is also absorbed, and due to the compressibility of the viscoelastic material, the contact area on the surface of pressure overwrap 2 is distributed (increases). Due to this, the total shock energy is partially absorbed by frame 5 and layers 10 made of the material of damping device 6 of shock absorber 4, and the remainder of the impact energy is transferred to the pressure overwrap 2 of the cylinder to the increased contact area compared to the original area at the moment of contact beginning. At the same time, a part of remaining energy causes deformation of pressure overwrap 2 and liner 1 in the form of deflection, arisen from the developing contact pressure in the zone of the junction of damping device 6 and the pressure overwrap 2, the other part is redistributed to damping device 6. Due to the fact that the damping device 6 of shock absorber 4 is fabricated in the form of damping assembly, consisting of braced layers of ballistic soft tissue substrate made of dry high-tenacity fibres 10 and the elastic layers 9, the fibres of layers of ballistic soft substrate 10 are deformed along its directions and additionally absorb the second part of the shock energy falling on pressure overwrap 2.

Thus, due to the partial absorption of the total impact energy by the shock absorber, a load affecting the pressure overwrap 2 and liner 1 is essentially decreased.

Diversity of the shock absorber design parameters helps to control deformability of pressure overwrap and to ensure the general reliability of the cylinder construction.

To assess the effectiveness of the construction, the following parameter is advisable to use as a criterion: no damage in the impact zone on the inside of an internal rigid overwrap, its deflection is within specified limits.

The condition of the energy balance of the system during the impact can be expressed as:

K−W₁−W₂−W₃−K₂=0

### Where

K—normal component of the kinetic energy of impact;
W₁—energy spent on the compression damping assembly of the damping device of the shock absorber;
W₂—energy spent on flexural deformation of pressure the cylinder overwrap and liner;
W₃—energy spent on flexural deformation of outer layers 2 and shock absorber frame;
K—kinetic energy of movement of all parts of the construction in the impact zone.

Based on the above condition of the system energy balance, and taking into account a number of assumptions with regard to the properties of the materials used, in the first approximation in order to determine the force F falling on the pressure overwrap, the following expression may be obtained:

$$\frac{m {V}_{n}^{2}}{2} = \frac{{Sh}_{1}^{2 / 3} {F}^{5 / 3}}{5 {( 2 / 3 R θ )}^{1 / 3}} + \frac{8 {F}^{3}}{27 {π}^{2} {C}^{2} {E}_{s}^{2} {{h}_{2}^{5} ( {k}_{1} + {k}_{2} )}^{2}} .$$

Where: F—contact force; h1, h2—thickness of the damping device and of the overwrap and frame in total, respectively, k1, k2—reduced surface curvature in the contact zone; Es—reduced modulus of overwrap material elasticity with regard to the material of the frame; h1—reduced thickness of the damping device layers; S, Θ-parameters characterizing the properties of the material of the damping device.

The first summand on the right side takes into account the energy of the contact compression of the damping device of the shock absorber, the second summand—the flexural energy of the frame of the shock absorber and pressure overwrap.

The mean value of contact pressure, falling on the pressure overwrap, is determined from the formula:

q=0.6F/π(2h)(k₁+k₂).

Analysis of the formula allows to notice that the effectiveness of the construction under consideration depends on the following design and material parameters: shape of the overwrap (or rather a ratio of the geometric curvatures of the overwrap under consideration), layer thickness ratio of the damping device and overwraps, a ratio of modulus of elasticity and modulus of strength of the used materials in the layers under consideration. By varying these parameters, one can finally select an optimum design solution, which, for a given value of the rigid overwrap deflection, provides a minimum weight of the construction together with impenetrability for specified kinetic energy of impact.

Based on the evaluation of the numerical results for the different versions of model samples design patterns, the following may be noted:
to increase the effectiveness of protective layers 10 of damping device 6, it is expedient to increase their thickness without a significant increase in the capacity of reinforcement (the total number of filaments), the energy to be absorbed is proportional to (h/a)^{c}, where h is a thickness of soft layers; a is a half-width of the contact area of an impactor and soft protection; c is a constant for the material used;
increase of the flexural stiffness of frame 5 results in the reduction of the dynamic deflection and increase of the contact forces of interaction, resulting in an increase in stress in the material of the frame structure;
reduction of the total thickness of frame 5 overwrap wall results in an increase in deflection but, at the same time, decreases the contact force, and, therefore, stresses in the material and pressure overwrap envelope;
a significant increase of wall thickness of pressure overwrap 2 changes the physics of its operation, i.e., in contrast to the thin overwrap, where the energy is absorbed due to a deflection of the overwrap, in a thick overwrap the energy absorption is due to the destruction of its strength (in particular, the cut-off layers of material);
introduction of two separating layers (layers with zero stiffness characteristics) into the wall of the pressure overwrap with purpose to provide its flexibility (reduced flexural stiffness), does not qualitatively change the results of the contact interaction;
the introduction of two layers into the wall of the pressure overwrap with purpose to increase the flexural stiffness results in the increase of contact pressures and stresses in the overwrap;
the introduction of two layers into the wall of the pressure overwrap with purpose to increase the inertia mass, qualitatively changes the results of the contact interaction;
alteration of impact parameters (in particular impact angle, the velocity and weight of an impactor) does not qualitatively change the overall picture of the behaviour of structures of model samples, and affects only the magnitude of the deflection;
alteration of the geometry of overwrap 2 (in particular, R1, R2) does not qualitatively change the overall picture of the behaviours of the structures of model samples, and affects only the magnitude of the deflection;
with regard to the stiffness parameters and the resulting pressure-contact interaction, the most effective constructive design is a thin-walled multilayer overwrap with a high membrane rigidity.

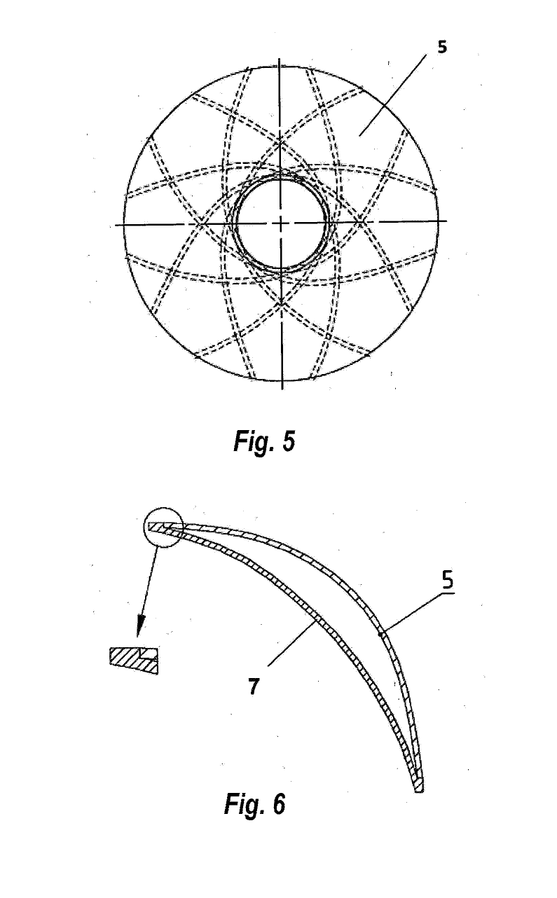

These considerations allow making a rational choice of the construction of shock absorber 4 and the cylinder overwrap 2 in general. Thus, FIGS. 4-6 show possible versions of the design of frame 5 of shock absorber 4 that help to optimize the construction mass characteristics. According to these figures the frame overwrap 5 may be smooth as well as ribbed with different arrangement of reinforcing ribs.

In the design of damping device made as a group of layers 10 ballistic tissue soft substrate, it is advisable to use the soft tissues fabricated from dry high-tenacity fibres covered with release hydro-oleophobic coating. The use of such layers can significantly improve the absorption of impact energy due to high strength and deformability of the layers. Fiberglass and aramid fibres are recommended to use for these layers. Use of these materials allows varying the size the damping device by changing the technological parameters of the tissues structure.

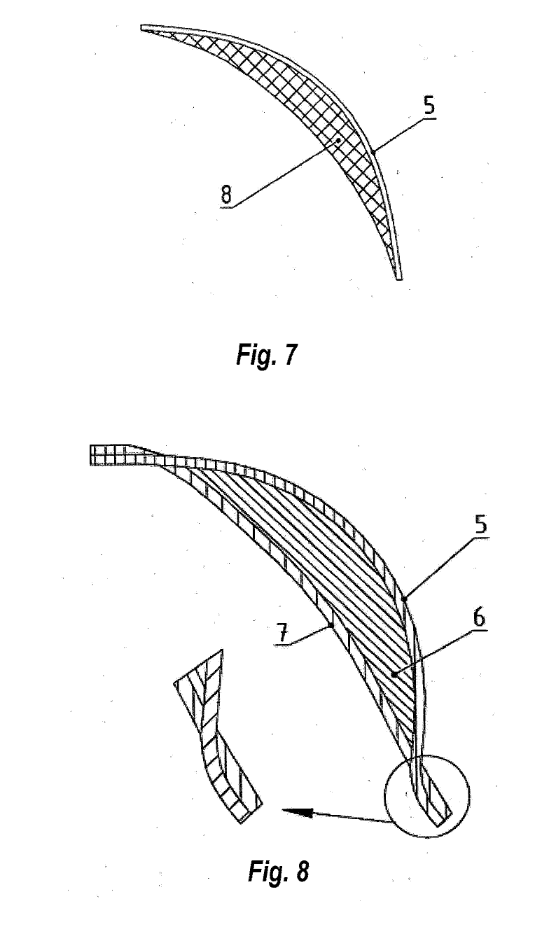

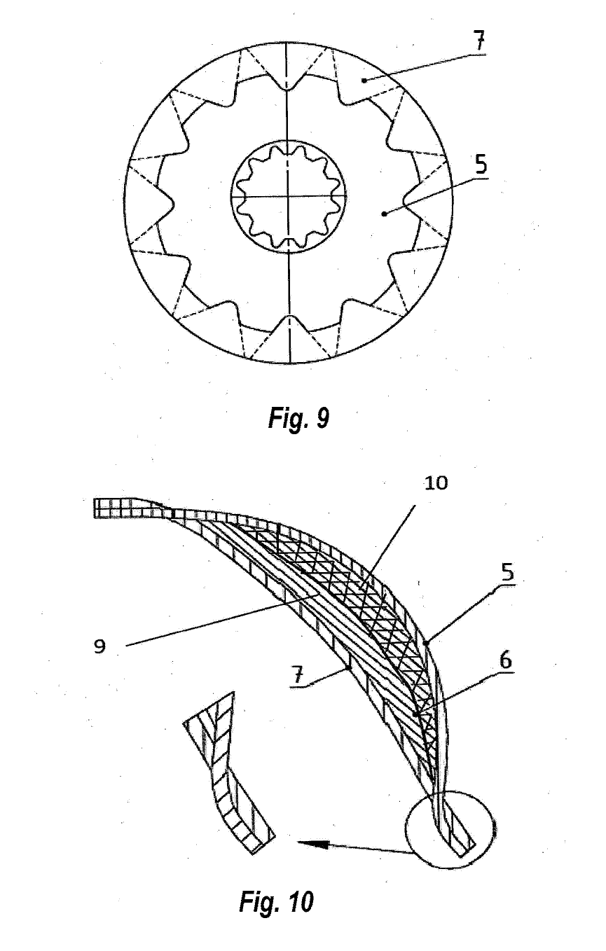

It is important that layers 10 of material fabricated from the dry high-tenacity fibres shall be fastened to frame 5 and is located in the space between frame 5, and a covering layer 7 secured with each other. FIGS. 7, 8 show the version of damping device design secured with covering layer 7, supporting material 10 made of dry high-tenacity fibres. Dry high-tenacity fibres may be placed as a set of braced damping ribbons made of high-tenacity material, which are mounted and fixed in the section chord of elliptical overwrap of the frame, forming star-shaped configuration with multiple rays. FIG. 9 shows this design version.

If covering layer has substantial strain stiffness, the shock absorber may be fabricated without the use of dry high-tenacity fibres. FIG. 10 shows this design version. Covering layer may be fabricated from viscoelastic damping material 9. This version of the design is shown in FIG. 11.

Thus, if the cylinder is fabricated as per the above design, protection of the cylinder pressure overwrap and liner from impact effect is guaranteed, and the impact does not affect general operational integrity of the cylinder structure.

### INDUSTRIAL APPLICABILITY

The invention is used in portable oxygen breathing apparatus for climbers, rescue workers, in portable devices of cryogenic and fire-fighting equipment, gas supply systems, automotive and other industries. The proposed device provides a real opportunity to use high-pressure vessels made of different materials with use of welded thin metal inner overwrap, liner. Fabrication and testing of high-pressure vessels with the proposed liner for their sealing, confirmed their high reliability and efficiency.

1. A metal composite pressure cylinder that contains
a closed thin metal sealing liner,
a pressure overwrap made of composite material formed by a combination of groups of layers of reinforcing material made of high-modulus filaments extending in spiral and circumferential directions,
a protective overwrap fabricated from composite material made of a group of layers of reinforcing material made of to low-modulus filaments,
an energy damping shock absorber installed on part of the surface of at least one of the bottoms, between the group of high-modulus reinforcing material of pressure overwrap and a group of the layers of low-modulus reinforcing material of protective overwrap, the shock absorber having a rigid profiled frame on the side of the protective overwrap and a damping device on the side of the pressure overwrap which are interconnected.

2. The cylinder defined in claim 1, wherein the profiled frame of the shock absorber is fabricated as an overwrap in the shape of a part of ellipsoid of revolution with a curvature that is greater than the curvature of the power overwrap surface.

3. The cylinder defined in claim 1, wherein the profiled frame of the shock absorber is fabricated in the form of the system of intersecting overwraps, arranged in rows with formation of cavities in the places of their connection.

4. The cylinder defined in claim 1, wherein the profiled frame of the shock absorber is fabricated as a profiled ribbed elastic overwrap.

5. The cylinder defined in claim 1, wherein the profiled frame of the shock absorber on the places of contact with the pressure overwrap is fabricated in the form of a crown, on the petals of which of a damping device is fixed.

6. The cylinder defined in claim 1, wherein the damping device of the shock absorber is fabricated as a damping assembly consisting of braced layers of ballistic soft tissue substrate made of dry high-tenacity fibers covered with release hydro-oleophobic coating, layers of low density viscoelastic material, and the covering layer of elastic moisture-proof material on the side of the pressure overwrap.

7. The cylinder defined in claim 6, wherein the layers of ballistic soft substrate of the damping device are fabricated from a set of braced damping filaments made of high-tenacity material, which are mounted and fixed in the section chord of elliptical overwrap of the frame, forming a star-shaped configuration, or layers of soft tissue substrate made of dry high-tenacity (aramid) fibers are fixed on the profiled frame on the crown petals with use of cross-cut slits in the tissue forming layers.
